(19) United States
(12) Patent Application Publication
(10) Pub. No.: US 2007/0292689 A1
(43) Pub. Date: Dec. 20, 2007

(54) Process For The Manufacture Of Fibre-Containing Plastic Granulates

(76) Inventor: Jan O.P. Pavlinec, Frankfurt Am Main (DE)

Correspondence Address: WILLIAM COLLARD;COLLARD & ROE, P.C., 1077 NORTHERN BOULEVARD, ROSLYN, NY, 11576, US

(21) Appl. No.: 11/597,463

(22) PCT Filed: Apr. 28, 2005
(86) PCT No.: PCT/EP05/04566

§ 371 Date: Nov. 22, 2006

(30) Foreign Application Priority Data
May 27, 2004 (DE) 10 2004 026 493.7

(51) Int. Cl. B29B 9/14; C08L 23/06; C08L 23/10

(52) U.S. Cl. 428/407; 264/257; 524/556; 524/567; 524/582; 524/585

(57) ABSTRACT

The invention relates to an inexpensive method for producing fiber-containing plastic granulate. According to the method, a fiber strand is fully enveloped by an at least partly heat-shrinkable plastic film so as to form an overlapping zone of the film ends, and the overlapping zone is welded before the enveloped fiber stand is thermally treated, cooled, and granulated. The invention also relates to fiber-containing plastic granulates obtained with the aid of the method as well as the use thereof.

The present invention relates to a process for the manufacture of fibre-containing plastic granulate, together with the fibre-containing plastic granulates obtainable by this process and their use.

Amongst other applications fibre-containing plastic granulates are used as starting materials in the manufacture of fibre-reinforced moulded plastic parts in order to increase e.g. the mechanical strength or the electrical conductivity of the moulded parts by the content of fibres in dependence upon the nature of the fibres. Normally, such fibre-containing plastic granulates comprise bundles of fibres having a length of 1 to 20 mm and a diameter of 1 to 5 mm and are enveloped by a layer of plastic or are embedded in this plastic.

The manufacture of these granulates is usually carried out by means of pultrusion or extraction processes where the fibre ropes to be enveloped are led through a melt containing a thermoplastic and then through a heated nozzle to an extruder before the enveloped fibre ropes are cooled and chopped to length in a granulating device. The disadvantage of these processes is the high cost of a process requiring the maintenance of a plastic melt together with the cost of the associated equipment. Furthermore these processes are inflexible since whenever the starting material is changed to suit each new diameter of the fibre rope, it is necessary in each case to fit a new heated nozzle.

It has already been proposed for the manufacture of plastic granulates for the fibre ropes to be enveloped to be drawn through a fluid bed containing a suitable plastic granulate before the thus impregnated fibre ropes are heated to melt the plastic granulates on the fibres and subsequently drawn through a heated nozzle or a heated roll assembly or the like with the purpose of obtaining a uniform coating of the fibre ropes before these are cooled and finally granulated. However, these processes also are characterized by high operational costs and the need for expensive equipment.

The object of the present invention is, therefore, to make available an alternative, cost-effective process for the manufacture of fibre-containing plastic granulate which is, in particular, also variable in terms of the diameter of the fibre ropes which are used.

According to the invention this object is achieved by a process according to patent Claim 1.

In the context of the present invention it was found, surprisingly, that fibre ropes can be tightly and completely surrounded or enveloped by a plastic film without extruders or extruder-like devices such as heated nozzles or the like. Consequently, in the process according to the invention, fibre ropes of different diameters may be used without the need for any modification of the device required to carry out the process. Since it is not necessary for the fibre ropes to be led through a melt or impregnated with plastic in a fluid bed but they are rather enveloped in an already-manufactured plastic film, it is possible in comparison with the processes known according to the prior art to produce granulates with a higher fibre content, namely more than 99% by weight. As a consequence of the very small content of plastic material, the granulates are compatible with each of the thermoplastic materials used in the customary injection-moulding processes. In addition, the process according to the invention can be carried out in a cost-effective manner.

In principle, all the plastic films known to the expert can be employed in the process according to the invention for enveloping the fibre ropes, to the extent that they possess at least a partial heat-shrink capability. In the context of the present invention it has, however, been shown that particularly good results are obtained with plastic films which preferably exhibit a heat-shrinkage factor of 20 to 70%, particularly preferably of 40 to 70% and very particularly preferably of 50 to 70%. For example, polyethylene, polyvinyl chloride, polyethylene terephthalate, polypropylene and copolymers are suitable film materials.

As an extension of the principle of the invention it is proposed that the fibre ropes be surrounded by the plastic film in a form that based on the longitudinal axis of the fibre rope produces a spiral-shaped or axial overlapping area, since such overlapping areas can be easily welded. In that respect it can be advantageous if the overlaps take the form of lips.

The welding of the overlapping areas can be effected by all the methods known to the expert for this purpose and, in particular, by the use of continuously operating film-welding equipment.

In the context of the present invention all staple fibre ropes and endless fibre ropes can be used as fibrous material. It has also shown to be advantageous if, before being enveloped in plastic film, the fibre rope is pretreated with a softening agent.

The duration of the heat treatment and the level of the temperature for this process stage depend in the first instance upon the heat-shrinkage behaviour, the material and the thickness of the plastic film being used and lies, preferably, between 50 and 180° C., particularly preferably between 50 and 150° C. and very particularly preferably between 50 and 100° C. As a result of the heat treatment the plastic film envelope shrinks until it lies tightly against the rope of fibres.

According to a particular exemplary embodiment of the present invention the process is carried out on a continuous basis, e.g. in that the fibre rope, possibly pretreated with a softening agent, is preferably first led from a drum, bobbin or container through a packaging device, in which it is completely surrounded by the plastic film and the overlapping areas are welded, after which the enveloped rope is processed through a heating zone and finally led to a cutting granulator. Alternatively, the heating zone can be integrated in the packaging device. After the heating zone and before being processed in a, for example customary, cutting granulator, the enveloped fibre rope travels sufficiently far that it is cooled, preferably to room temperature. Alternatively, a cooling device can also be provided to achieve this objective.

A further object of the present invention is a fibre-containing plastic granulate obtainable by means of the process according to the invention.

Preferably, the fibre content of the granulate according to the invention amounts to 60 to 99.5% by weight, particularly preferably 90 to 99.5% by weight and very particularly preferably 95 to 99.5% by weight.

The diameter and the length of the granulate is determined to suit the purpose of the following application, where the diameter of the granulate lies preferably between 1 and 5 mm, particularly preferably between 1.5 and 5 mm and very particularly preferably between 2.5 and 5 mm and the length of the granulates lies preferably between 2 and 15 mm, particularly preferably between 3 and 10 mm and very particularly preferably between 4 and 6 mm.

The plastic granulates according to the invention are suitable, amongst other applications, for the manufacture of all types of fibre-reinforced plastic moulded parts.

The invention is described in greater detail with the aid of exemplary embodiments and the drawing. All the described or depicted characteristics in this case form the object of the invention, regardless of whether or not they are summarized in the claims or circumstances relating to them.

In the drawing:

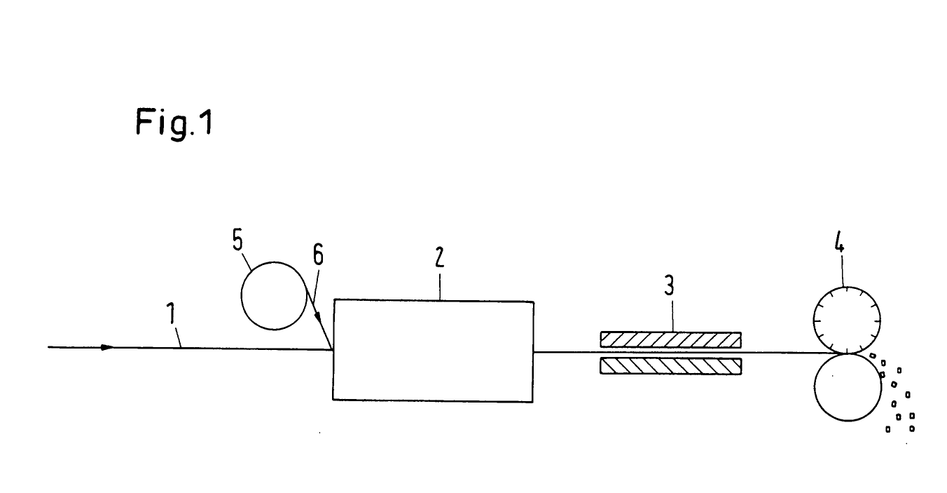

FIG. 1 shows a process diagram of a process and a device for the manufacture of fibre-containing plastic granulate according to an exemplary embodiment of the present invention,

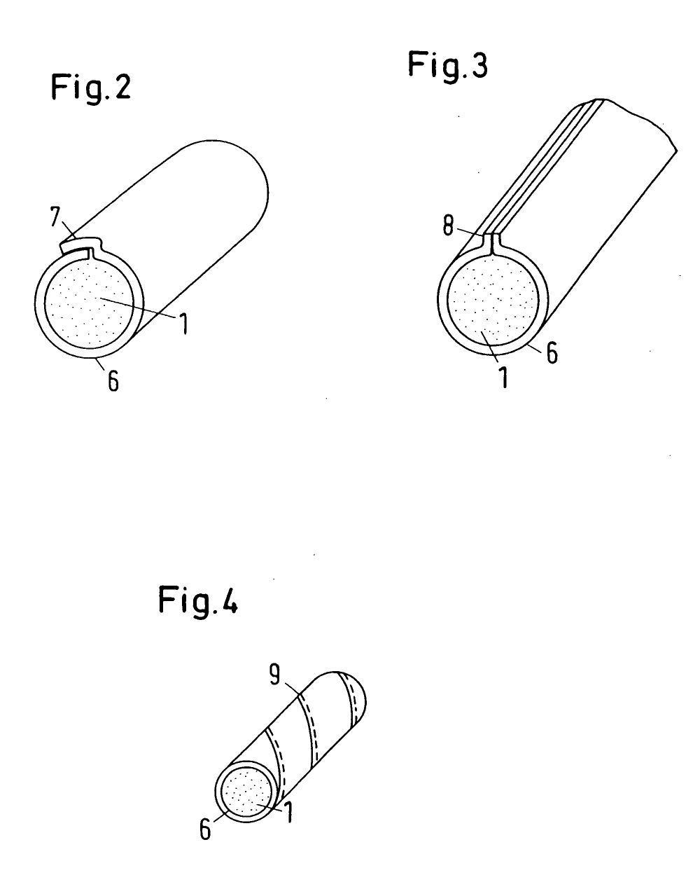

FIG. 2 shows the schematic cross section of a fibre-containing plastic granulate according to a first exemplary embodiment of the present invention,

FIG. 3 shows the schematic cross section of a fibre-containing plastic granulate according to a second exemplary embodiment of the present invention, and

FIG. 4 shows the schematic cross section of a fibre-containing plastic granulate according to a third exemplary embodiment of the present invention.

In the process illustrated in FIG. 1, a fibre rope 1 is led continuously by a suitable drive (not illustrated) and successively through a packaging device 2, a heating zone 3 and a cutting granulator 4.

In the packaging device 2 the fibre rope 1 is completely surrounded by a plastic film 6 with a heat-shrink capability which is supplied to the fibre rope 1 from a film band bobbin 5, which is preferably part of the packaging device 2 but which is shown separately in FIG. 1 purely for the sake of clarity so as to generate an overlapping area of the film ends 7, 8, 9 and subsequently the ends in the overlapping areas 7, 8, 9 are welded together by, for example, the use of heat and pressure. As shown in FIGS. 2 to 4 the envelopment of the fibre rope 1 with the film 6 can be carried out in such a manner that the ends of the film based on the longitudinal axis of the fibre rope 1 overlap axially 7, axially while forming a lip 8 or to result in a spiral form 9. During the following processing of the thus enveloped fibre rope 1 through the heating zone 3, the film 6 shrinks until it lies tightly against the fibre rope 1, with the length of the heating zone 3 and the temperature maintained within it being selected to suit the shrinkage properties of the film 6 being used. After the heating zone 3, the enveloped fibre rope 1 travels sufficiently far that it is cooled, preferably to room temperature, before being processed in a cutting granulator 4.

### LIST OF REFERENCE NUMERALS

1 Fibre rope
2 Packaging device
3 Heating zone
4 Cutting granulator
5 Film band bobbin
6 Plastic film
7 Overlapping area of the ends of the film with axial envelopment
8 Overlapping lip of the ends of the film with axial envelope envelopment
9 Overlapping area of the ends of the film with radial (spiral-shaped) envelopment

1: Process for the manufacture of fibre-containing plastic granulate, wherein a fibre rope (1) is completely enveloped by a plastic film (6) having an at least partial heat-shrinkage capability while the ends of the film form an overlapping area (7, 8, 9) and the overlapping area (7, 8, 9) is welded before the thus enveloped fibre rope (1) is subjected to heat treatment, cooled and granulated.

2: Process according to claim 1, wherein a plastic film (6) with a heat-shrinkage factor of 20 to 70%, particularly preferably of 40 to 70% and very particularly preferably of 50 to 70% is used.

3: Process according to claim 1, wherein a plastic film (6) made of polyethylene, polyvinyl chloride, polyethylene terephthalate, polypropylene and/or copolymer is used.

4: Process according to claim 1, wherein the fibre rope (1) is surrounded by the plastic film (6) in a form that based on the longitudinal axis of the fibre rope produces a spiral-shaped (9) or axial overlapping area (7, 8).

5: Process according to claim 1, wherein the overlapping area takes the form of a lip (8).

6: Process according to claim 1, wherein a staple fibre rope or an endless fibre rope is used as the fibre rope (1).

7: Process according to claim 1, wherein the heat treatment is carried out at a temperature of between 50 and 180° C., particularly preferably between 50 and 150° C. and very particularly preferably between 50 and 100° C.

8: Process according to claim 1, wherein this is carried out on a continuous basis.

9: Fibre-containing plastic granulate obtainable from a process according to claim 1.

10: Plastic granulate according to claim 9, wherein the fibre content amounts to 60 to 99.5% by weight, particularly preferably 90 to 99.5% by weight and very particularly preferably 95 to 99.5% by weight.

11: Plastic granulate according to claim 9, wherein the diameter of the granulate lies between 1 and 5 mm, particularly preferably between 1.5 and 5 mm and very particularly preferably between 2.5 and 5 mm and the length of the granulate lies between 2 and 15 mm, particularly preferably between 3 and 10 mm and very particularly preferably between 4 and 6 mm.

12: Use of a fibre-containing plastic granulate according to claim 1 for the manufacture of fibre-reinforced moulded plastic parts.
